(19) United States
(12) Patent Application Publication
(10) Pub. No.: US 2024/0406888 A1
(43) Pub. Date: Dec. 5, 2024

(54) METHOD AND APPARATUS FOR DETERMINING POWER CONTROL PC PARAMETER, AND TERMINAL

(71) Applicant: VIVO MOBILE COMMUNICATION CO., LTD., Guangdong (CN)

(72) Inventor: Yu YANG, Guangdong (CN)

(73) Assignee: VIVO MOBILE COMMUNICATION CO., LTD., Guangdong (CN)

(21) Appl. No.: 18/799,400

(22) Filed: Aug. 9, 2024

Related U.S. Application Data
(63) Continuation of application No. PCT/CN2023/074418, filed on Feb. 3, 2023.

(30) Foreign Application Priority Data
Feb. 9, 2022 (CN) 202210122881.9
Oct. 14, 2022 (CN) 202211262378.X

(51) Int. Cl. H04W 52/36; H04L 5/00; H04W 16/28; H04W 52/08; H04W 52/24; H04W 76/20

(52) U.S. Cl. CPC H04W 52/367; H04L 5/0051; H04W 16/28; H04W 52/08; H04W 52/242; H04W 76/20

(57) ABSTRACT

A method and an apparatus for determining a power control PC parameter, and a terminal. The method includes: A terminal receives common beam information configured by a network side device, where the beam information includes M pieces of joint transmission configuration indicator TCI state information or separate TCI state information; when the TCI state information is associated with or includes a PC parameter, the terminal determines, based on the PC parameter associated with or included in the TCI state information, a PC parameter of an SRS resource to which the TCI state information is applied; and/or when the TCI state information is not associated with or does not include a PC parameter, the terminal determines, based on a PC parameter included in configuration information of a sounding reference signal SRS resource set, a PC parameter of an SRS resource to which the TCI state information is applied.

### CROSS-REFERENCE TO RELATED APPLICATIONS

This application is a continuation of International Application No. PCT/CN2023/074418 filed on Feb. 3, 2023, which claims priority to Chinese Patent Application No. 202210122881.9 filed on Feb. 9, 2022, and to Chinese Patent Application No. 202211262378.X filed on Oct. 14, 2022, which are incorporated herein by reference in their entireties.

### TECHNICAL FIELD

This application belongs to the field of communication technologies, and specifically, to a method and an apparatus for determining a power control PC parameter, and a terminal.

### BACKGROUND

A meaning of power control (PC) in a current technology includes: maintaining a power (where the power is adjusted based on a distance between a terminal and a base station, to ensure that powers of signals arriving at the base station are similar); improving performance (where a power is adjusted dynamically based on a channel change, to accurately and quickly adjust the power); and reducing interference (where power leakage of an adjacent channel is reduced, inter-user and inter-cell interference is reduced, and battery life is prolonged).

Division of the power control is as follows:
downlink power control, mainly depending on configuration and implementation on a network side; and
uplink power control, mainly including PC of a physical uplink shared channel (PUSCH), PC of a physical uplink control channel (PUCCH), PC of a sounding reference signal (SRS), and PC of a physical random access channel (PRACH).

The power control further includes power headroom report (PHR), mainly for assisting the base station in scheduling; and power scaling (Power sharing), mainly for sharing a power and ensuring transmission of a cell/channel with a high priority.

On one hand, a new unified transmission configuration indicator (TCI) framework is introduced in a 5th generation (5G) communication system, and may be referred to as a unified TCI framework. To be specific, a same beam indicated by a network by using a media access control control element (MAC CE) and/or downlink control information (DCI) may be used for transmission of a plurality of channels. The beam may also be referred to as a common beam. The unified TCI framework includes two modes: a joint TCI mode and a separate TCI mode, and is configured by using radio resource control (RRC) signaling of the network. A joint TCI state indication specifically includes indicating that a TCI state is used for both uplink transmission and downlink transmission; and a separate TCI state indication specifically includes indicating that a TCI state is used for uplink transmission or downlink transmission.

On the other hand, multi-transmission and reception point (multi-TRP, which may be referred to as MTRP for short) transmission is introduced in 5G. Signaling control is classified into two cases: single-DCI scheduling and multi-DCI scheduling.

Multi-DCI (which may be referred to as mDCI for short) scheduling: Each transmission and reception point (TRP) transmits a respective PDCCH, and each PDCCH schedules a respective physical downlink shared channel (PDSCH). In this case, a plurality of control resource sets (CORESETs) configured by a network for user equipment (UE) are associated with different CORESET pool indexes (CORESETPoolindexes) of RRC parameters, and correspond to different TRPs.

Single-DCI (which may be referred to as sDCI for short) scheduling: A PDCCH is transmitted by a TRP to schedule a PDSCH. In this case, a plurality of CORESETs configured by a network for UE cannot be associated with different CORESETPoolIndexes. In this case, the MAC CE activates a maximum of 8 codepoints, where at least one codepoint corresponds to two TCI states. When a codepoint indicated by a TCI field in DCI corresponds to two TCI states and indicates that a TCI state includes “QCL-TypeD”, it means that a scheduled PDSCH is from two TRPs.

However, the unified TCI framework is currently applied to only a single-TRP scenario, and there is no solution to how to determine an uplink power control parameter when the unified TCI framework is applied to a multi-TRP scenario.

### SUMMARY

Embodiments of this application provide a method and an apparatus for determining a power control PC parameter, and a terminal.

According to a first aspect, a method for determining a power control PC parameter is provided, and the method includes:

A terminal receives common beam information configured by a network side device, where the beam information includes M pieces of joint transmission configuration indicator TCI state information or M pieces of separate TCI state information, and M is an integer greater than or equal to 1;
when the TCI state information is associated with or includes a PC parameter, the terminal determines, based on the PC parameter associated with or included in the TCI state information, a PC parameter of an SRS resource to which the TCI state information is applied; and/or
when the TCI state information is not associated with or does not include a PC parameter, the terminal determines, based on a PC parameter included in configuration information of a sounding reference signal SRS resource set, a PC parameter of an SRS resource to which the TCI state information is applied.

According to a second aspect, an apparatus for determining a power control PC parameter is provided, and the apparatus includes:
a first receiving module, configured to receive common beam information configured by a network side device, where the beam information includes M pieces of joint transmission configuration indicator TCI state information or M pieces of separate TCI state information, and M is an integer greater than or equal to 1;
a first determining module, configured to: when the TCI state information is associated with or includes a PC parameter, determine, based on the PC parameter associated with or included in the TCI state information, a PC parameter of an SRS resource to which the TCI state information is applied; and/or
a second determining module, configured to: when the TCI state information is not associated with or does not include a PC parameter, determine, based on a PC parameter included in configuration information of a sounding reference signal SRS resource set, a PC parameter of an SRS resource to which the TCI state information is applied.

According to a third aspect, a terminal is provided. The terminal includes a processor and a memory. The memory stores a program or instructions executable on the processor, and when the program or the instructions are executed by the processor, the steps of the method in the first aspect are implemented.

According to a fourth aspect, a terminal is provided, including a processor and a communication interface. The communication interface is configured to receive common beam information configured by a network side device, where the beam information includes M pieces of joint transmission configuration indicator TCI state information or M pieces of separate TCI state information, and M is an integer greater than or equal to 1. The processor is configured to: when the TCI state information is associated with or includes a PC parameter, determine, based on the PC parameter associated with or included in the TCI state information, a PC parameter of an SRS resource to which the TCI state information is applied; and/or the processor is configured to: when the TCI state information is not associated with or does not include a PC parameter, determine, based on a PC parameter included in configuration information of a sounding reference signal SRS resource set, a PC parameter of an SRS resource to which the TCI state information is applied.

According to a fifth aspect, a readable storage medium is provided. The readable storage medium stores a program or instructions, and when the program or the instructions are executed by a processor, the steps of the method in the first aspect are implemented.

According to a sixth aspect, a chip is provided. The chip includes a processor and a communication interface. The communication interface is coupled to the processor, and the processor is configured to run a program or instructions, to implement the method in the first aspect.

According to a seventh aspect, a computer program/program product is provided. The computer program/program product is stored in a storage medium, and the computer program/program product is executed by at least one processor to implement the steps of the method in the first aspect.

### BRIEF DESCRIPTION OF THE DRAWINGS

FIG. 1 is a block diagram of a wireless communication system to which an embodiment of this application may be applied;

FIG. 2 is a step flowchart of a method for determining a PC parameter according to an embodiment of this application;

FIG. 3 is a schematic diagram of a structure of an apparatus for determining a PC parameter according to an embodiment of this application;

FIG. 4 is a schematic diagram 1 of a structure of a terminal according to an embodiment of this application; and

FIG. 5 is a schematic diagram 2 of a structure of a terminal according to an embodiment of this application.

### DETAILED DESCRIPTION

The technical solutions in embodiments of this application are clearly described below with reference to the accompanying drawings in embodiments of this application. It is clear that the described embodiments are some rather than all of embodiments of this application. All other embodiments obtained by a person skilled in the art based on embodiments of this application fall within the protection scope of this application.

In this specification and claims of this application, the terms “first”, “second”, and so on are intended to distinguish similar objects but do not indicate a specific order or sequence. It should be understood that the terms used in this way are exchangeable in a proper case, so that embodiments of this application can be implemented in sequences other than those illustrated or described herein. The objects distinguished by “first” and “second” are usually a class, and a quantity of the objects is not limited. For example, a first object may be one or a plurality of objects. In addition, “and/or” in the specification and claims means at least one of connected objects, and a character “/” usually means that a preceding and succeeding related objects are in an “or” relationship.

It is worth noting that technologies described in embodiments of this application are not limited to a long term evolution (LTE)/LTE-Advanced (LTE-A) system, and may alternatively be applied to another wireless communication system, such as code division multiple access (CDMA), time division multiple access (TDMA), frequency division multiple access (FDMA), orthogonal frequency division multiple access (OFDMA), single-carrier frequency division multiple access (SC-FDMA), and another system. The terms “system” and “network” in embodiments of this application are often used interchangeably, and the described technologies may be used in the foregoing systems and wireless technologies, or may be used in other systems and wireless technologies. A new radio (NR) system is described in the following descriptions as an example, and NR terms are used in most of the following descriptions, but the technologies may alternatively be applied to an application, such as a 6th generation (6G) communication system, other than an NR system application.

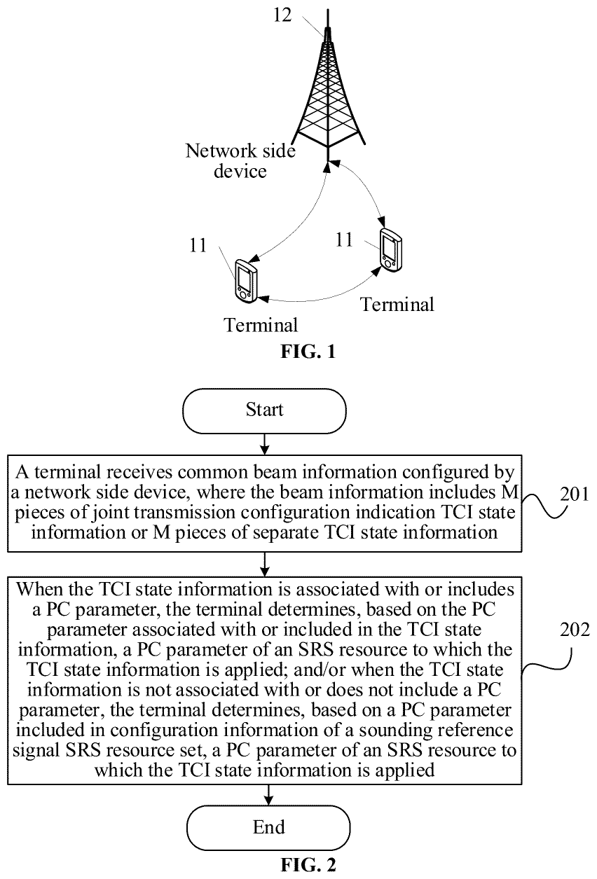

FIG. 1 is a block diagram of a wireless communication system to which an embodiment of this application may be applied. The wireless communication system includes a terminal 11 and a network side device 12. The terminal 11 may be a terminal-side device, such as a mobile phone, a tablet computer (Tablet Personal Computer), a laptop computer, or referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or furniture), a game machine, a personal computer (PC), a teller machine, or a self-service machine. The wearable device includes a smart watch, a smart band, a smart earphone, smart glasses, smart jewelry (a smart bracelet, a smart chain bracelet, a smart ring, a smart necklace, a smart anklet, a smart chain anklet), a smart wristband, smart clothing, and the like. It should be noted that, in this embodiment of this application, a specific type of the terminal 11 is not limited. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission and reception point (TRP), or another suitable term in the art. Provided that a same technical effect is achieved, the base station is not limited to a specific technical term. It should be noted that, in this embodiment of this application, only a base station in a new radio (NR) system is used as an example for description, and a specific type of the base station is not limited.

A method for determining a power control PC parameter according to embodiments of this application is described in detail below by using some embodiments and application scenarios thereof with reference to the accompanying drawings.

FIG. 2 is a step flowchart of a method for determining a power control PC parameter according to an embodiment of this application. The method for determining a PC parameter includes the following steps.
Step 201: A terminal receives common beam information configured by a network side device, where the beam information includes M pieces of joint transmission configuration indicator TCI state information or M pieces of separate TCI state information, and M is an integer greater than or equal to 1.

In this step, the M pieces of joint TCI state information may be understood as M pieces of TCI state information that are simultaneously for uplink transmission and downlink transmission. The M pieces of separate TCI state information may be understood as M pieces of TCI state information for uplink transmission, M pieces of TCI state information for downlink transmission, or Ml pieces of TCI state information for uplink transmission and M2 pieces of TCI state information for downlink transmission, where M1+M2 is equal to M. It should be noted that the “TCI state information” mentioned in this embodiment of this application may be any one of the foregoing M pieces of joint TCI state information or any one of the foregoing M pieces of separate TCI state information. This is not specifically limited herein.
Step 202: When the TCI state information is associated with or includes a PC parameter, the terminal determines, based on the PC parameter associated with or included in the TCI state information, a PC parameter of a sounding reference signal (SRS) resource to which the TCI state information is applied; and/or when the TCI state information is not associated with or does not include a PC parameter, the terminal determines, based on a PC parameter included in configuration information of a sounding reference signal SRS resource set, a PC parameter of an SRS resource to which the TCI state information is applied.

It should be noted that the “PC parameter” in the “when the TCI state information is associated with or includes a PC parameter” and the “when the TCI state information is not associated with or does not include a PC parameter” mentioned in this embodiment of this application may be specifically a set of PC parameters or a part of PC parameters in a set of PC parameters. The set of PC parameters includes a path loss reference signa and/or a parameter setting. The parameter setting includes at least one of a target power value P0 of an open loop receive end, a partial path loss compensation factor α, and a close loop power control index (Close Loop Index, CLI).

If the PC parameter is a part of PC parameters in a set of PC parameters, for example, when the TCI state information is associated with or includes a first part of PC parameters in the set of PC parameters (where the TCI state information is not associated with or does not include a second part of PC parameters in the set of PC parameters), a first part of PC parameters of the SRS resource to which the TCI state information is applied are the first part of the PC parameters associated with or included in the TCI state information, and a second part of PC parameters of the SRS resource to which the TCI state information is applied are determined based on the configuration information of the SRS resource set.

It should be noted that, when M is greater than 1, all of the M pieces of TCI state information may be associated with or include the PC parameter. Alternatively, none of the M pieces of TCI state information is associated with or includes the PC parameter. Alternatively, a part of the M pieces of TCI state information are associated with or include the PC parameter, and a part of the M pieces of TCI state information are not associated with or do not include the PC parameter.

Optionally, when M is greater than 1, M may be understood as a quantity of TRPs. For example, when M is equal to 2, the plurality of pieces of TCI state information are TCI state information respectively corresponding to TRPs. When M is equal to 1, the TCI state information is TCI state information of a TRP in a plurality of TRPs or TCI state information common to all TRPs.

It should be noted that, in a multi-TRP scenario to which this embodiment of this application is applied, when N is equal to 1, there are the following two cases:

Case 1: In a multi-DCI scheduling case, the terminal may determine, based on that a network configures a plurality of pieces of different TRP identity (ID) information (for example, CORESETPoolIndexes of RRC parameters), that the terminal is in a multi-DCI mode in the multi-TRP scenario. In this scenario, the terminal may further determine, based on received DCI, that a scheduled channel corresponds to a TRP. Specifically, one piece of TCI state information is indicated in the DCI. The TCI state information may be for determining that the scheduled channel corresponds to a TRP in a plurality of TRPs (where an uplink channel to which the TCI state information is applied may be understood as an uplink channel of the TRP corresponding to the TCI state information).

Case 2: In a single-DCI scheduling case, the terminal may indirectly determine, based on configuration information of a network, for example, based on a quantity of TCI states corresponding to each codepoint in codepoints activated by using a MAC CE, that the terminal is in the multi-TRP scenario. In this scenario, the terminal determines, based on a TCI state corresponding to a codepoint indicated by received DCI, that a scheduled channel corresponds to one or more TRPs. When the codepoint indicated by the DCI corresponds to one TCI state, the TCI state may be for determining that an uplink channel scheduled by using the DCI applies the TCI state information and corresponds to a TRP in a plurality of TRPs.

In an optional embodiment, the PC parameter includes a path loss reference signa (PLRS) and/or a parameter setting. The parameter setting includes at least one of a target power value P0 of an open loop receive end, a partial path loss compensation factor α, and a close loop power control index CLI.

In an optional embodiment, the network may configure an SRS resource set, or the network may configure a plurality of SRS resource sets.

In at least one embodiment of this application, step 202 in which when the TCI state information is associated with or includes the PC parameter, the terminal determines, based on the PC parameter associated with or included in the TCI state information, the PC parameter of the SRS resource to which the TCI state information is applied includes:

When the network configures a first SRS resource set, the terminal determines the PC parameter of the SRS resource that is in the first SRS resource set and to which the TCI state information is applied as:
the PC parameter associated with or included in the TCI state information used by the SRS resource; or
a PC parameter associated with or included in preset TCI state information.

For example, the first SRS resource set includes K SRS resources, where K is an integer greater than or equal to 1. Optionally, the method is applied to a multi-DCI scenario with a plurality of TRPs.

In an optional embodiment, when K is equal to 1, in other words, when the first SRS resource set includes one SRS resource, the terminal determines that the SRS resource uses the preset TCI state information, and a PC parameter of the SRS resource is the PC parameter associated with or included in the preset TCI state information. The preset TCI state information is any one of the following:
a P^{th} piece of TCI state information in the M pieces of TCI state information, where for example, P is equal to 1 or 2, and a value of P is configured by the network or is pre-agreed;
TCI state information corresponding to same first identification information as the SRS resource, where if a P^{th} piece of TCI state information in the M pieces of TCI state information corresponds to certain first identification information, and the SRS resource also corresponds to the same first identification information, the SRS resource uses the P^{th} piece of TCI state information; and
TCI state information corresponding to the SRS resource, where for example, a correspondence between the SRS resource and the TCI state information is configured by the network or is pre-agreed.

Optionally, the first identification information includes at least one of the following:
identification information of a control resource set CORESET;
identification information of a CORESET pool;
identification information of a transmission and reception point TRP;
identification information of a channel group;
identification information of a CORESET group; and
identification information of a physical uplink control channel PUCCH resource group.

In another optional embodiment, when K is greater than or equal to 2 (for example, K is equal to 2), in other words, when the first SRS resource set includes a plurality of SRS resources, and M is greater than 1, the terminal determines the PC parameter of the SRS resource that is in the first SRS resource set and to which the TCI state information is applied as: the PC parameter associated with or included in the TCI state information used by the SRS resource.

Correspondingly, the method further includes:

The terminal determines, based on first identification information associated with each SRS resource in the first SRS resource set, that TCI state information used by the SRS resource is the TCI state information corresponding to the first identification information.

Optionally, the first identification information includes at least one of the following:
identification information of a control resource set CORESET;
identification information of a CORESET pool;
identification information of a transmission and reception point TRP;
identification information of a channel group;
identification information of a CORESET group; and
identification information of a physical uplink control channel PUCCH resource group.

For example, in the mDCI scenario, the K SRS resources are respectively associated with different TRP IDs (different CORESET pool indexes). In this case, the K SRS resources respectively use TCI state information corresponding to each TRP ID, and use a PC parameter associated with or included in each piece of TCI state information.

Further, when the network configures a first SRS resource set, PC parameters associated with or included in the M pieces of TCI state information are the same, to ensure that PC parameters of all SRS resources in the first SRS resource set are the same. In other words, in this embodiment of this application, the PC parameters included in or associated with the TCI state information indicated by the network are limited to be the same.

Alternatively, when the network configures a first SRS resource set, PC parameters associated with or included in the M pieces of TCI state information are different. In other words, in this embodiment of this application, the PC parameters included in or associated with the TCI state information indicated by the network are allowed to be different.

It should be noted that, when the network configures an SRS resource set (namely, the first SRS resource set), and the set includes the K SRS resources, each SRS resource in the K SRS resources uses one piece of TCI state information indicated by the network. Different SRS resources may use same or different TCI state information.

In another optional embodiment, when M is equal to 1, all SRS resources included in the first SRS resource set use one piece of TCI state information included in the common beam information. In addition, if the TCI state information is associated with or includes a PC parameter, PC parameters of all the SRS resources included in the first SRS resource set are the PC parameter associated with or included in the TCI state information.

In another optional embodiment, when M is equal to 1, a target SRS resource in the first SRS resource set uses one piece of TCI state information included in the common beam information. Another SRS resource other than the target SRS resource may not be transmitted, or TCI state information and a PC parameter of the another SRS resource do not change.

The target SRS resource includes at least one of the following:
an SRS resource having a correspondence with the TCI state information; and
an SRS resource corresponding to same first identification information as the TCI state information.
   Optionally, the first identification information includes at least one of the following:
identification information of a control resource set CORESET;
identification information of a CORESET pool;
identification information of a transmission and reception point TRP;
identification information of a channel group;
identification information of a CORESET group; and
identification information of a physical uplink control channel PUCCH resource group.

For example, there is a correspondence between the target SRS resource and the TCI state information indicated by the network, or the target SRS resource and the TCI state information indicated by the network correspond to a same channel group, CORESET group, or TRP ID.

In at least one embodiment of this application, step 202 in which the terminal determines, based on the PC parameter associated with or included in the TCI state information, the PC parameter of the SRS resource to which the TCI state information is applied includes:

When the network configures a plurality of second SRS resource sets, the terminal determines a PC parameter of a second SRS resource set to which the TCI state information is applied as:
a PC parameter associated with or included in the TCI state information used by the second SRS resource set.

PC parameters of all SRS resources included in the second SRS resource set are the same. To be specific, PC parameters of all SRS resources included in a same second SRS resource set are the same, and PC parameters of SRS resources included in different second SRS resource sets may be the same or different.

For example, the network configures P second SRS resource sets, and each second SRS resource set includes at least one SRS resource set. Optionally, the method is applied to a single-DCI scenario. P is greater than 1.

When M is greater than 1, the P second SRS resource sets respectively use one piece of TCI state information indicated by the network. TCI state information used by different second SRS resource sets may be the same or different. For example, all SRS resources in an SRS resource set A use first TCI state information, and all SRS resources in an SRS resource set B use second TCI state information. In this case, the method further includes:

The terminal determines, based on a first correspondence, the TCI state information used by the second SRS resource set, where the first correspondence includes any one of the following:
a correspondence between the SRS resource set and an identifier of the TCI state information; and
a correspondence between the SRS resource set and the first identification information.

The first identification information includes at least one of the following:
identification information of a CORESET;
identification information of a CORESET pool;
identification information of a TRP;
identification information of a channel group;
identification information of a CORESET group; and
identification information of a PUCCH resource group.

When M is equal to 1, all the plurality of second SRS resource sets use one piece of TCI state information included in the common beam information. In addition, if the TCI state information is associated with or includes a PC parameter, PC parameters of the plurality of second SRS resource sets are all the PC parameter associated with or included in the TCI state information.

In an alternative case, details are as follows.

When M is equal to 1, a target second SRS resource set in the plurality of second SRS resource sets uses one piece of TCI state information included in the common beam information, and a remaining second SRS resource set may not be transmitted, or TCI state information and a PC parameter of the remaining second SRS resource set do not change.

The target second SRS resource set includes at least one of the following:
a second SRS resource set having a correspondence with the TCI state information; and
a second SRS resource set corresponding to same first identification information as a TCI state information. The first identification information includes at least one of the following:
identification information of a CORESET;
identification information of a CORESET pool;
identification information of a TRP;
identification information of a channel group;
identification information of a CORESET group; and
identification information of a PUCCH resource group.

For example, there is a correspondence between the target second SRS resource set and the TCI state information, or the target second SRS resource set and the TCI state information correspond to a same channel group, CORESET group, or TRP ID.

In at least one embodiment of this application, step 202 in which the terminal determines, based on the PC parameter included in the configuration information of the sounding reference signal SRS resource set, the PC parameter of the SRS resource to which the TCI state information is applied includes:

When the network configures a first SRS resource set, the terminal determines that a PC parameter of an SRS resource that is in the first SRS resource set and that uses TCI state information that is not associated with or does not include a PC parameter is a PC parameter included in configuration information of the first SRS resource set.

Alternatively, when the network configures a first SRS resource set, the terminal determines PC parameters of all SRS resources in the first SRS resource set as PC parameters included in configuration information of the first SRS resource set.

It should be noted that, if the first SRS resource set is associated with a plurality of sets of PC parameters in the configuration information of the first SRS resource set, the plurality of sets of PC parameters may respectively correspond to the SRS resources in the first SRS resource set. Alternatively, if the first SRS resource set is associated with only one set of PC parameters in the configuration information of the first SRS resource set, the set of PC parameters is applicable to all the SRS resources in the first SRS resource set.

Alternatively, step 202 in which the terminal determines, based on the PC parameter included in the configuration information of the sounding reference signal SRS resource set, the PC parameter of the SRS resource to which the TCI state information is applied includes:

When the network configures the plurality of second SRS resource sets, the terminal determines the PC parameter of the second SRS resource set to which the TCI state information is applied as:
the PC parameter included in the configuration information of the second SRS resource set, where the PC parameters of all the SRS resources included in the second SRS resource set are the same.

It should be noted that, if the second SRS resource set is associated with the plurality of sets of PC parameters in the configuration information of the second SRS resource set, a default PC parameter of the second SRS resource set may be pre-agreed. This is not specifically limited herein.

In at least one embodiment of this application, when the TCI state information is associated with or includes the PC parameter, the terminal determines, based on a target configuration, the PC parameter of the SRS resource to which the TCI state information is applied as the PC parameter associated with or included in the TCI state information or as a configured first PC parameter.

The target configuration may indicate whether all or a part of PC parameters of an SRS resource or all SRS resources included in an SRS resource set are applied to the PC parameter associated with or included in the TCI state information. For example, if the target configuration indicates a first state, the SRS resource or the SRS resource set applies the PC parameter associated with or included in the TCI state information. Alternatively, if the target configuration indicates a second state, the SRS resource or all the SRS resources included in the SRS resource set apply the preconfigured first PC parameter.

Optionally, the target configuration is an RRC parameter srs-PowerControlAdjustmentStates of the SRS resource set, and a value thereof may be sameAsFci2 or separateClosedLoop. When srs-PowerControlAdjustmentStates is configured as sameAsFci2 or srs-PowerControlAdjustmentStates is not configured, the SRS resource or all the SRS resources included in the SRS resource set use one piece of TCI state information included in the common beam information. If the TCI state information is associated with or includes the PC parameter, the PC parameter (for example, a close loop power control index (Close Loop Index, CLI)) of the SRS resource or the PC parameters of all the SRS resources included in the SRS resource set are the PC parameter associated with or included in the TCI state information. When srs-PowerControlAdjustmentStates is configured as separateClosedLoop, the SRS resource or all the SRS resources included in the SRS resource set use an additionally configured first PC parameter (for example, a close loop power control index (Close Loop Index, CLI)).

In conclusion, in this embodiment of this application, for a scenario in which a unified TCI framework is applied to a plurality of TRPs, after receiving the M pieces of TCI state information indicated by the network, the terminal determines, based on the PC parameter associated with or included in the TCI state information, the PC parameter of the SRS resource to which the TCI state information is applied, and/or determines, based on the PC parameter included in the configuration information of the sounding reference signal SRS resource set, the PC parameter of the SRS resource to which the TCI state information is applied, to ensure correctness of SRS power adjustment and SRS transmission performance.

An execution entity of the method for determining a power control PC parameter according to this embodiment of this application may be an apparatus for determining a power control PC parameter. In this embodiment of this application, an example in which the apparatus for determining the power control PC parameter performs the method for determining the power control PC parameter is used, to describe the apparatus for determining the power control PC parameter according to this embodiment of this application.

FIG. 3 is an apparatus 300 for determining a power control PC parameter according to an embodiment of this application. The apparatus 300 for determining a PC parameter includes:
a first receiving module 301, configured to receive common beam information configured by a network side device, where the beam information includes M pieces of joint transmission configuration indicator TCI state information or M pieces of separate TCI state information, and M is an integer greater than or equal to 1;
a first determining module 302, configured to: when the TCI state information is associated with or includes a PC parameter, determine, based on the PC parameter associated with or included in the TCI state information, a PC parameter of an SRS resource to which the TCI state information is applied; and/or
a second determining module 303, configured to: when the TCI state information is not associated with or does not include a PC parameter, determine, based on a PC parameter included in configuration information of a sounding reference signal SRS resource set, a PC parameter of an SRS resource to which the TCI state information is applied.

In an optional embodiment, the first determining module 302 includes:
a first determining submodule, configured to determine, when a network configures a first SRS resource set, the PC parameter of the SRS resource that is in the first SRS resource set and to which the TCI state information is applied as:
the PC parameter associated with or included in the TCI state information used by the SRS resource; or
a PC parameter associated with or included in preset TCI state information.

In an optional embodiment, when M is equal to 1, all SRS resources included in the first SRS resource set use one piece of TCI state information included in the common beam information.

In an alternative case, details are as follows.

When M is equal to 1, a target SRS resource in the first SRS resource set uses one piece of TCI state information included in the common beam information. The target SRS resource includes at least one of the following:
an SRS resource having a correspondence with the TCI state information; and
an SRS resource corresponding to same first identification information as the TCI state information.

In an optional embodiment, when M is greater than 1, and the first SRS resource set includes a plurality of SRS resources, the apparatus further includes:
a third determining module, configured to determine, based on first identification information associated with each SRS resource in the first SRS resource set, that the TCI state information used by the SRS resource is TCI state information corresponding to the first identification information.

In an optional embodiment, the first determining module includes:
a second determining submodule, configured to determine, when a network configures a plurality of second SRS resource sets, a PC parameter of a second SRS resource set to which the TCI state information is applied as:
a PC parameter associated with or included in the TCI state information used by the second SRS resource set.

PC parameters of all SRS resources included in the second SRS resource set are the same.

In an optional embodiment, when M is equal to 1, all the plurality of second SRS resource sets use one piece of TCI state information included in the common beam information.

In an alternative case, details are as follows.

When M is equal to 1, a target second SRS resource set in the plurality of second SRS resource sets uses one piece of TCI state information included in the common beam information. The target second SRS resource set includes at least one of the following:
a second SRS resource set having a correspondence with the TCI state information; and
a second SRS resource set corresponding to same first identification information as a TCI state information.

In an optional embodiment, when M is greater than 1, the apparatus further includes: a fourth determining module, configured to determine, based on a first correspondence, TCI state information used by the second SRS resource set. The first correspondence includes any one of the following:
a correspondence between the SRS resource set and an identifier of the TCI state information; and
a correspondence between the SRS resource set and the first identification information.

In an optional embodiment, when the network configures the first SRS resource set, PC parameters associated with or included in the M pieces of TCI state information are the same.

In an alternative case, details are as follows.

When the network configures the first SRS resource set, PC parameters associated with or included in the M pieces of TCI state information are different.

In an optional embodiment, when the first SRS resource set includes one SRS resource, the preset TCI state information is any one of the following:
a P^{th} piece of TCI state information in the M pieces of TCI state information;
TCI state information corresponding to same first identification information as the SRS resource; and
TCI state information corresponding to the SRS resource.

In an optional embodiment, the second determining module includes:
a third determining submodule, configured to determine, when a network configures a first SRS resource set, a PC parameter of an SRS resource that is in the first SRS resource set and that uses TCI state information that is not associated with or does not include a PC parameter as a PC parameter included in configuration information of the first SRS resource set; or
a fourth determining submodule, configured to determine, when a network configures a first SRS resource set, PC parameters of all SRS resources in the first SRS resource set as PC parameters included in configuration information of the first SRS resource set.

In an optional embodiment, the second determining module includes:
a fourth determining submodule, configured to determine, when a network configures a plurality of second SRS resource sets, a PC parameter of a second SRS resource set to which the TCI state information is applied as:
a PC parameter included in configuration information of the second SRS resource set, where PC parameters of all SRS resources included in the second SRS resource set are the same.

In an optional embodiment, the first identification information includes at least one of the following:
identification information of a control resource set CORESET;
identification information of a CORESET pool;
identification information of a transmission and reception point TRP;
identification information of a channel group;
identification information of a CORESET group; and
identification information of a physical uplink control channel PUCCH resource group.

In an optional embodiment, the PC parameter includes a path loss reference signa and/or a parameter setting. The parameter setting includes at least one of a target power value P0 of an open loop receive end, a partial path loss compensation factor α, and a close loop power control index CLI.

In an optional embodiment, the first determining module is configured to determine, based on a target configuration, the PC parameter of the SRS resource to which the TCI state information is applied as the PC parameter associated with or included in the TCI state information or as a configured first PC parameter.

In this embodiment of this application, for a scenario in which a unified TCI framework is applied to a plurality of TRPs, after receiving the M pieces of TCI state information indicated by a network, the terminal determines, based on the PC parameter associated with or included in the TCI state information, the PC parameter of the SRS resource to which the TCI state information is applied, and/or determines, based on the PC parameter included in the configuration information of the sounding reference signal SRS resource set, the PC parameter of the SRS resource to which the TCI state information is applied, to ensure correctness of SRS power adjustment and SRS transmission performance.

It should be noted that the apparatus for determining a PC parameter according to this embodiment of this application is an apparatus that can perform the foregoing method for determining a PC parameter, and all embodiments of the foregoing method for determining a PC parameter are applicable to the apparatus, and the same or similar beneficial effects can be achieved.

The apparatus for determining a PC parameter in this embodiment of this application may be an electronic device, for example, an electronic device having an operating system, or may be a component in an electronic device, for example, an integrated circuit or a chip. The electronic device may be a terminal, or may be another device other than the terminal. For example, the terminal may include, but is not limited to, the foregoing listed types of the terminal 11, and the another device may be a server, a network attached storage (NAS), or the like. This is not specifically limited in this embodiment of this application.

The apparatus for determining a PC parameter according to this embodiment of this application can implement processes implemented in the method embodiments of FIG. 1 and FIG. 2, and the same technical effects are achieved. To avoid repetition, details are not described herein again.

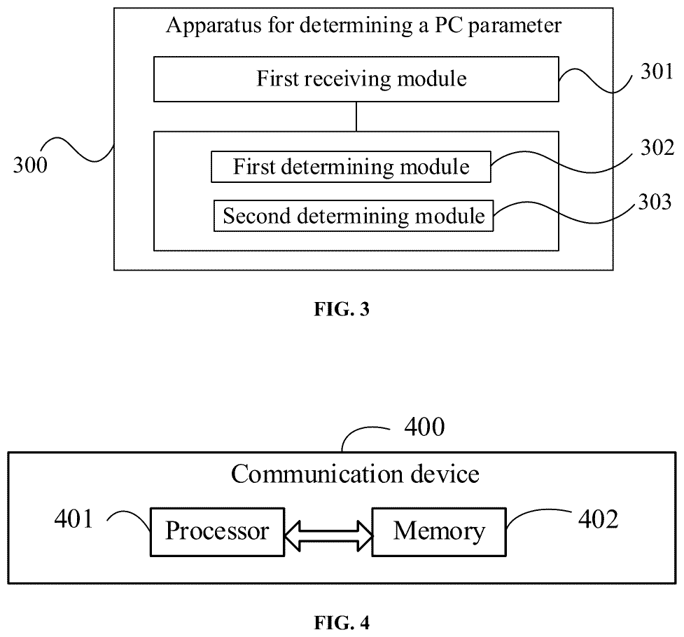

Optionally, as shown in FIG. 4, an embodiment of this application further provides a terminal 400, including a processor 401 and a memory 402. The memory 402 stores a program or instructions executable on the processor 401. When the program or the instructions are executed by the processor 401, the steps of the foregoing embodiments of the method for determining a power control PC parameter are implemented, and the same technical effects can be achieved. To avoid repetition, details are not described herein again.

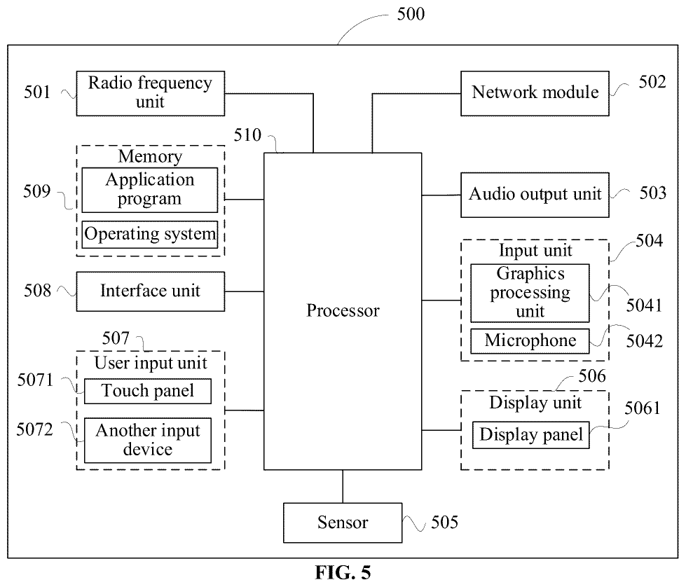

An embodiment of this application further provides a terminal, including a processor and a communication interface. The communication interface is configured to receive common beam information configured by a network side device. The beam information includes M pieces of joint transmission configuration indicator TCI state information or M pieces of separate TCI state information, and M is an integer greater than or equal to 1. The processor is configured to: when the TCI state information is associated with or includes a PC parameter, determine, based on the PC parameter associated with or included in the TCI state information, a PC parameter of an SRS resource to which the TCI state information is applied; and/or the processor is configured to: when the TCI state information is not associated with or does not include a PC parameter, determine, based on a PC parameter included in configuration information of a sounding reference signal SRS resource set, a PC parameter of an SRS resource to which the TCI state information is applied. The terminal embodiment corresponds to the foregoing terminal-side method embodiment. Each implementation process and implementation of the foregoing method embodiment are applicable to the terminal embodiment, and the same technical effects can be achieved. Specifically, FIG. 5 is a schematic diagram of a hardware structure of a terminal implementing an embodiment of this application.

The terminal 500 includes, but is not limited to, at least a part of components in a radio frequency unit 501, a network module 502, an audio output unit 503, an input unit 504, a sensor 505, a display unit 506, a user input unit 507, an interface unit 508, a memory 509, and a processor 510.

A person skilled in the art may understand that the terminal 500 may further include a power supply (for example, a battery) for supplying power to the components. The power supply may be logically connected to the processor 510 by using a power management system, so that functions such as charging, discharging, and power consumption management are implemented by using the power management system. The terminal structure shown in FIG. 5 does not constitute a limitation to the terminal, and the terminal may include more components or fewer components than those shown in the figure, or some components may be combined, or a different component deployment may be used. Details are not described herein again.

It should be understood that, in this embodiment of this application, the input unit 504 may include a graphics processing unit (GPU) 5041 and a microphone 5042. The graphics processing unit 5041 processes image data of a still picture or a video captured by an image capture apparatus (for example, a camera) in a video capture mode or an image capture mode. The display unit 506 may include a display panel 5061, and the display panel 5061 may be configured in a form of a liquid crystal display, an organic light emitting diode, or the like. The user input unit 507 includes at least one of a touch panel 5071 and another input device 5072. The touch panel 5071 is also referred to as a touchscreen. The touch panel 5071 may include two parts: a touch detection apparatus and a touch controller. The another input device 5072 may include, but is not limited to, a physical keyboard, a function key (for example, a volume control key and a switch key), a trackball, a mouse, and an operating rod. Details are not described herein.

In this embodiment of this application, after receiving downlink data from the network side device, the radio frequency unit 501 may transmit the downlink data to the processor 510 for processing. In addition, the radio frequency unit 501 may transmit uplink data to the network side device. The radio frequency unit 501 usually includes, but is not limited to, an antenna, an amplifier, a transceiver, a coupler, a low-noise amplifier, a duplexer, and the like.

The memory 509 may be configured to store a software program or instructions and various data. The memory 509 may mainly include a first storage area storing the program or the instructions and a second storage area storing the data. The first storage area may store an operating system, an application program or instructions required for at least one function (for example, a sound playback function and an image playback function), and the like. In addition, the memory 509 may include a volatile memory or a non-volatile memory, or the memory 509 may include both a volatile and a non-volatile memory. The non-volatile memory may be a read-only memory (ROM) a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 509 in this embodiment of this application includes, but is not limited to, these and any other suitable types of memories.

The processor 510 may include one or more processing units. Optionally, the processor 510 integrates an application processor and a modem processor. The application processor mainly processes operations related to an operating system, a user interface, an application program, and the like. The modem processor, such as a baseband processor, mainly processes a wireless communication signal. It may be understood that the foregoing modem processor may alternatively not be integrated into the processor 510.

The radio frequency unit 501 is configured to receive the common beam information configured by the network side device, where the beam information includes the M pieces of joint transmission configuration indicator TCI state information or the M pieces of separate TCI state information, and M is the integer greater than or equal to 1.

The processor 510 is configured to: when the TCI state information is associated with or includes the PC parameter, determine, based on the PC parameter associated with or included in the TCI state information, the PC parameter of the SRS resource to which the TCI state information is applied; and/or the processor is configured to: when the TCI state information is not associated with or does not include the PC parameter, determine, based on the PC parameter included in the configuration information of the sounding reference signal SRS resource set, the PC parameter of the SRS resource to which the TCI state information is applied.

In this embodiment of this application, for a scenario in which a unified TCI framework is applied to a plurality of TRPs, after receiving the M pieces of TCI state information indicated by a network, the terminal determines, based on the PC parameter associated with or included in the TCI state information, the PC parameter of the SRS resource to which the TCI state information is applied, and/or determines, based on the PC parameter included in the configuration information of the sounding reference signal SRS resource set, the PC parameter of the SRS resource to which the TCI state information is applied, to ensure correctness of SRS power adjustment and SRS transmission performance.

It should be noted that the apparatus for determining a PC parameter according to this embodiment of this application is an apparatus that can perform the foregoing method for determining a PC parameter, and all embodiments of the foregoing method for determining a PC parameter are applicable to the apparatus, and the same or similar beneficial effects can be achieved.

An embodiment of this application further provides a readable storage medium. The readable storage medium stores a program or instructions. When the program or the instructions are executed by a processor, processes of the foregoing embodiments of the method for determining a power control PC parameter are implemented, and the same technical effects can be achieved. To avoid repetition, details are not described herein again.

The processor is the processor in the terminal of the foregoing embodiment. The readable storage medium includes a computer-readable storage medium, such as a computer read-only memory ROM, a random access memory RAM, a magnetic disk, or an optical disk.

An embodiment of this application further provides a chip. The chip includes a processor and a communication interface. The communication interface is coupled to the processor. The processor is configured to run a program or instructions, to implement processes of the foregoing embodiments of the method for determining a power control PC parameter, and the same technical effects can be achieved. To avoid repetition, details are not described herein again.

It should be understood that the chip mentioned in this embodiment of this application may also be referred to as a system-level chip, a system chip, a chip system, a system-on-chip, or the like.

An embodiment of this application further provides a computer program/program product. The computer program/program product is stored in a storage medium. The computer program/program product is executed by at least one processor to implement processes of the foregoing embodiments of the method for determining a power control PC parameter, and the same technical effects can be achieved. To avoid repetition, details are not described herein again.

It should be noted that the terms “include”, “comprise” and any other variants mean to cover the non-exclusive inclusion, so that the process, method, article, or apparatus which include a series of elements not only include those elements, but also include other elements which are not clearly listed, or include inherent elements of the process, method, article, or apparatus. Without further limitation, an element defined by “including a/an . . . ” does not exclude the existence of other identical elements in the process, method, article, or apparatus that includes the element. In addition, it should be noted that the scope of the method and apparatus in embodiments of this application is not limited to performing the functions in an order shown or discussed, but may further include performing the functions in a substantially simultaneous manner or in a reverse order according to the involved functions. For example, the described methods may be performed in an order different from the described order, and various steps may further be added, omitted, or combined. In addition, features described with reference to some examples may be combined in other examples.

Through descriptions of the foregoing implementations, a person skilled in the art may clearly learn that the method in the foregoing embodiment may be implemented by relying on software and a necessary general hardware platform or by using hardware, but the former one is preferred implementation in many cases. Based on such an understanding, the technical solutions of this application, which is essential or contributes to the conventional art, may be presented in a form of a computer software product. The computer software product is stored in a storage medium (for example, a ROM/RAM, a magnetic disk, or an optical disc) including several instructions to enable a terminal (which may be a mobile phone, a computer, a server, an air conditioner, a network device, or the like) to perform the methods described in embodiments of this application.

Embodiments of this application are described above with reference to the accompanying drawings. However, this application is not limited to the foregoing specific implementations. The foregoing specific implementations are merely illustrative and not restrictive. A person of ordinary skill in the art, under the teachings of this application, may make many forms without departing from the spirit of this application and the protection scope of the claims, and all fall within the protection of this application.

What is claimed is:

1. A method for determining a power control (PC) parameter, wherein the method comprises:
receiving, by a terminal, common beam information configured by a network side device, wherein the beam information comprises M pieces of joint transmission configuration indicator (TCI) state information or M pieces of separate TCI state information, and M is an integer greater than or equal to 1;
in a case that the TCI state information is associated with or comprises a PC parameter, determining, by the terminal based on the PC parameter associated with or comprised in the TCI state information, a PC parameter of an SRS resource to which the TCI state information is applied; and/or
in a case that the TCI state information is not associated with or does not comprise a PC parameter, determining, by the terminal based on a PC parameter comprised in configuration information of a sounding reference signal (SRS) resource set, a PC parameter of an SRS resource to which the TCI state information is applied.

2. The method according to claim 1, wherein the determining, by the terminal based on the PC parameter associated with or comprised in the TCI state information, a PC parameter of an SRS resource to which the TCI state information is applied comprises:
in a case that a network configures a first SRS resource set, determining, by the terminal, the PC parameter of the SRS resource that is in the first SRS resource set and to which the TCI state information is applied as:
the PC parameter associated with or comprised in the TCI state information used by the SRS resource; or
a PC parameter associated with or comprised in preset TCI state information.

3. The method according to claim 2, wherein in a case that M is equal to 1, all SRS resources comprised in the first SRS resource set use one piece of TCI state information comprised in the common beam information; or
in a case that M is equal to 1, a target SRS resource in the first SRS resource set uses one piece of TCI state information comprised in the common beam information, wherein the target SRS resource comprises at least one of the following:
an SRS resource having a correspondence with the TCI state information; or
an SRS resource corresponding to same first identification information as the TCI state information.

4. The method according to claim 2, wherein in a case that M is greater than 1, and the first SRS resource set comprises a plurality of SRS resources, the method further comprises:
determining, by the terminal based on first identification information associated with each SRS resource in the first SRS resource set, that TCI state information used by the SRS resource is TCI state information corresponding to the first identification information.

5. The method according to claim 1, wherein the determining, by the terminal based on the PC parameter associated with or comprised in the TCI state information, a PC parameter of an SRS resource to which the TCI state information is applied comprises:
in a case that a network configures a plurality of second SRS resource sets, determining, by the terminal, a PC parameter of a second SRS resource set to which the TCI state information is applied as:
a PC parameter associated with or comprised in the TCI state information used by the second SRS resource set, wherein
PC parameters of all SRS resources comprised in the second SRS resource set are the same.

6. The method according to claim 5, wherein in a case that M is equal to 1, all the plurality of second SRS resource sets use one piece of TCI state information comprised in the common beam information; or
in a case that M is equal to 1, a target second SRS resource set in the plurality of second SRS resource sets uses one piece of TCI state information comprised in the common beam information, wherein the target second SRS resource set comprises at least one of the following:
a second SRS resource set having a correspondence with the TCI state information; or
a second SRS resource set corresponding to same first identification information as a TCI state information.

7. The method according to claim 5, wherein in a case that M is greater than 1, the method further comprises:
determining, by the terminal based on a first correspondence, the TCI state information used by the second SRS resource set, wherein the first correspondence comprises any one of the following:
a correspondence between the SRS resource set and an identifier of the TCI state information; or
a correspondence between the SRS resource set and the first identification information.

8. The method according to claim 2, wherein in the case that the network configures the first SRS resource set, PC parameters associated with or comprised in the M pieces of TCI state information are the same; or
in the case that the network configures the first SRS resource set, PC parameters associated with or comprised in the M pieces of TCI state information are different.

9. The method according to claim 2, wherein in a case that the first SRS resource set comprises one SRS resource, the preset TCI state information is any one of the following:
a P^{th} piece of TCI state information in the M pieces of TCI state information;
TCI state information corresponding to same first identification information as the SRS resource; or
TCI state information corresponding to the SRS resource.

10. The method according to claim 1, wherein the determining, by the terminal based on a PC parameter comprised in configuration information of a sounding reference signal (SRS) resource set, a PC parameter of an SRS resource to which the TCI state information is applied comprises:
in a case that the network configures a first SRS resource set, determining, by the terminal, that a PC parameter of an SRS resource that is in the first SRS resource set and that uses TCI state information that is not associated with or does not comprise a PC parameter is a PC parameter comprised in configuration information of the first SRS resource set; or
in a case that a network configures a first SRS resource set, determining, by the terminal, PC parameters of all SRS resources in the first SRS resource set as PC parameters comprised in configuration information of the first SRS resource set.

11. The method according to claim 1, wherein the determining, by the terminal based on a PC parameter comprised in configuration information of a sounding reference signal (SRS) resource set, a PC parameter of an SRS resource to which the TCI state information is applied comprises:
in a case that a network configures a plurality of second SRS resource sets, determining, by the terminal, a PC parameter of a second SRS resource set to which the TCI state information is applied as:
a PC parameter comprised in configuration information of the second SRS resource set, wherein PC parameters of all SRS resources comprised in the second SRS resource set are the same.

12. The method according to claim 3, wherein the first identification information comprises at least one of the following:
identification information of a control resource set (CORESET);
identification information of a CORESET pool;
identification information of a transmission and reception point (TRP);
identification information of a channel group;
identification information of a CORESET group; or
identification information of a physical uplink control channel (PUCCH) resource group.

13. The method according to claim 1, wherein the PC parameter comprises a path loss reference signa and/or a parameter setting, and the parameter setting comprises at least one of a target power value P0 of an open loop receive end, a partial path loss compensation factor α, or a close loop power control index (CLI).

14. The method according to claim 1, wherein in the case that the TCI state information is associated with or comprises the PC parameter, the method further comprises:
determining, by the terminal based on a target configuration, the PC parameter of the SRS resource to which the TCI state information is applied as the PC parameter associated with or comprised in the TCI state information or as a configured first PC parameter.

15. A terminal, comprising a processor and a memory, wherein the memory stores a program or instructions executable on the processor, wherein the program or the instructions, when executed by the processor, cause the terminal to perform:
receiving common beam information configured by a network side device, wherein the beam information comprises M pieces of joint transmission configuration indicator (TCI) state information or M pieces of separate TCI state information, and M is an integer greater than or equal to 1;
in a case that the TCI state information is associated with or comprises a PC parameter, determining, based on the PC parameter associated with or comprised in the TCI state information, a PC parameter of an SRS resource to which the TCI state information is applied; and/or
in a case that the TCI state information is not associated with or does not comprise a PC parameter, determining, based on a PC parameter comprised in configuration information of a sounding reference signal (SRS) resource set, a PC parameter of an SRS resource to which the TCI state information is applied.

16. The terminal according to claim 15, wherein when determining, based on the PC parameter associated with or comprised in the TCI state information, a PC parameter of an SRS resource to which the TCI state information is applied, the program or the instructions, when executed by the processor, cause the terminal to perform:
in a case that a network configures a first SRS resource set, determining the PC parameter of the SRS resource that is in the first SRS resource set and to which the TCI state information is applied as:
the PC parameter associated with or comprised in the TCI state information used by the SRS resource; or
a PC parameter associated with or comprised in preset TCI state information.

17. The terminal according to claim 15, wherein when determining, based on the PC parameter associated with or comprised in the TCI state information, a PC parameter of an SRS resource to which the TCI state information is applied, the program or the instructions, when executed by the processor, cause the terminal to perform:
in a case that a network configures a plurality of second SRS resource sets, determining a PC parameter of a second SRS resource set to which the TCI state information is applied as:
a PC parameter associated with or comprised in the TCI state information used by the second SRS resource set, wherein
PC parameters of all SRS resources comprised in the second SRS resource set are the same.

18. The terminal according to claim 17, wherein in a case that M is greater than 1, the program or the instructions, when executed by the processor, cause the terminal to further perform:
determining, based on a first correspondence, the TCI state information used by the second SRS resource set, wherein the first correspondence comprises any one of the following:
a correspondence between the SRS resource set and an identifier of the TCI state information; or
a correspondence between the SRS resource set and the first identification information.

19. The terminal according to claim 15, wherein the PC parameter comprises a path loss reference signa and/or a parameter setting, and the parameter setting comprises at least one of a target power value P0 of an open loop receive end, a partial path loss compensation factor α, or a close loop power control index (CLI).

20. A non-transitory readable storage medium, storing a program or instructions, wherein the program or the instructions, when executed by a processor of a terminal, cause the processor of the terminal to perform:
receiving common beam information configured by a network side device, wherein the beam information comprises M pieces of joint transmission configuration indicator (TCI) state information or M pieces of separate TCI state information, and M is an integer greater than or equal to 1;
in a case that the TCI state information is associated with or comprises a PC parameter, determining, based on the PC parameter associated with or comprised in the TCI state information, a PC parameter of an SRS resource to which the TCI state information is applied; and/or
in a case that the TCI state information is not associated with or does not comprise a PC parameter, determining, based on a PC parameter comprised in configuration information of a sounding reference signal (SRS) resource set, a PC parameter of an SRS resource to which the TCI state information is applied.
